(19) United States
(12) Patent Application Publication
(10) Pub. No.: US 2023/0112498 A1
(43) Pub. Date: Apr. 13, 2023

(54) INSPECTION SYSTEM AND METHOD FOR CONTROLLING INSPECTION SYSTEM

(71) Applicant: CANON KABUSHIKI KAISHA, Tokyo (JP)

(72) Inventor: Takeaki Itsuji, Kanagawa (JP)

(21) Appl. No.: 17/933,665

(22) Filed: Sep. 20, 2022

(30) Foreign Application Priority Data
Sep. 28, 2021 (JP) 2021-157911

(51) Int. Cl. G01N 21/3581; G06T 7/00; G01B 11/06

(52) U.S. Cl. CPC G01N 21/3581; G01B 11/0658; G06T 7/0004

(57) ABSTRACT

An inspection system for inspecting an object including a base and a coating layer includes: an emission unit configured to irradiate the object with a terahertz wave including at least a reference pattern; and a support unit configured to adjust a relative position between the emission unit and the object. The inspection system further includes: a detection unit configured to detect the terahertz wave reflected on the object and acquire a terahertz image; and a determination unit configured to determine, from a shape of the terahertz image, whether an incident angle of the terahertz wave on the object is a predetermined incident angle.

### BACKGROUND

### Field of the Disclosure

The present disclosure relates to an inspection system and a method for controlling the inspection system.

### Description of the Related Art

A terahertz-wave camera system has been studied. Japanese Patent Laid-Open No. 2018-087725 discloses a camera system that acquires an image by detecting a terahertz wave radiated from an emission unit and reflected on an object. In addition, Japanese Patent Laid-Open No. 2019-158820 discloses a system that inspects, via a non-metal coating layer that coats a flat-plate metal base, the surface roughness of the metal base.

### SUMMARY

An aspect of the present disclosure provides an inspection system for inspecting an object including a base and a coating layer that coats the base, the inspection system including: an emission unit configured to irradiate the object with a terahertz wave including at least a reference pattern; a support unit configured to adjust a relative position between the emission unit and the object; a detection unit configured to detect the terahertz wave reflected on the object and acquire a terahertz image; and a determination unit configured to determine, from a shape of the terahertz image, whether an incident angle of the terahertz wave on the object is a predetermined incident angle.

Another aspect of the present disclosure provides an inspection system including: an emission unit configured to oscillate a terahertz wave; a detection unit configured to detect the terahertz wave and acquire an image; a support unit configured to support an object including a base and a coating layer that coats the base; a determination unit configured to compare a first image serving as a reference and a second image acquired by detecting the terahertz wave reflected on the object with each other and determine whether an incident angle of the terahertz wave on the object is a predetermined incident angle; and a posture control unit configured to control, based on a result obtained by the determination unit, a posture of at least one of the emission unit, the detection unit, and the support unit.

Another aspect of the present disclosure provides a method for controlling an inspection system including: an emission unit configured to oscillate a terahertz wave; a detection unit configured to detect the terahertz wave; and a support unit configured to support an object, the method including: a step of oscillating a terahertz wave having a pattern and acquiring a first image serving as a reference; a step of detecting the terahertz wave reflected on the object and acquiring a second image; a step of comparing the first image and the second image with each other; and a step of controlling, based on a result obtained by the comparing, a posture of at least one of the emission unit, the detection unit, and the support unit.

Further features of various embodiments will become apparent from the following description of exemplary embodiments with reference to the attached drawings.

### BRIEF DESCRIPTION OF THE DRAWINGS

FIG. 1 is a schematic diagram for describing the configuration of an inspection system according to a first embodiment.

FIGS. 2A to 2C are schematic diagrams for describing patterns according to the first embodiment.

FIG. 3 is a flowchart for describing operations of the inspection system according to the first embodiment.

FIG. 4 is a flowchart for describing operations of the inspection system according to the first embodiment.

FIG. 5 is a flowchart for describing operations of the inspection system according to the first embodiment.

FIG. 6 is a flowchart for describing operations of the inspection system according to the first embodiment.

FIG. 7 is a schematic diagram for describing the configuration of the inspection system according to the first embodiment.

FIG. 8 is a diagram for describing an inspection system according to a second embodiment.

FIG. 9 is a schematic diagram for describing a camera system according to a third embodiment.

### DESCRIPTION OF THE EMBODIMENTS

Now, a terahertz-wave inspection system and a terahertz-wave camera system will be described in detail with reference to the drawings. In the description of the embodiments, the same configuration as that in another embodiment will be omitted from the description in some cases. In addition, the embodiments may be changed as appropriate or combined with another embodiment as appropriate. The inspection system described in the following embodiments can also be used as a camera system, and the camera system described in the following embodiments can also be used as an inspection system.

In the following description, a terahertz wave refers to an electromagnetic wave that is in the frequency range of greater than or equal to 10 GHz and less than or equal to 100 THz, more preferably, greater than or equal to 30 GHz and less than or equal to 30 THz.

The following issues may arise in a mechanism of a camera system that detects a terahertz wave regularly reflected on an object having a plurality of planes or a curved surface. For example, depending on the shape of an object and the positional relationship between an emission unit and a detection unit, the reflection angle of the terahertz wave from the object to pixels of the detection unit changes, and thus, an object image output from the detection unit may be distorted. In addition, a distribution of a signal change resulting from the shape of the object is superposed on the object image, and thus, highly accurate measurement may be difficult.

According to the embodiments below, it is possible to provide a terahertz-wave system that enables acquisition of a suitable image with little distortion or highly accurate measurement.

### First Embodiment

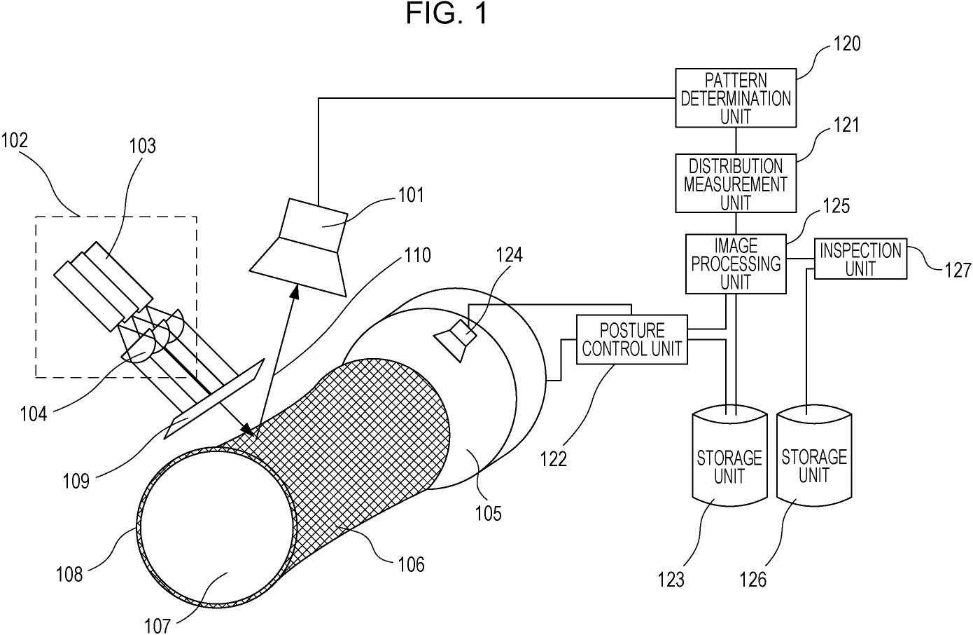

An inspection system according to this embodiment will be described with reference to FIG. 1. FIG. 1 is a schematic diagram for describing the configuration of the inspection system according to the first embodiment.

The inspection system includes a detection unit 101, an emission unit 102, and a support unit 105. The detection unit 101 is, for example, a terahertz-wave camera that can detect a terahertz wave. The emission unit 102 includes, for example, a plurality of generation elements 103 that radiate the terahertz wave. The generation elements 103 may be a surface light source formed by combining, as an array, a plurality of oscillation elements that oscillate the terahertz wave, and are driven in synchronization with each other. According to the arrangement of the plurality of oscillation elements, the shape of the surface light source, which is the generation elements 103, can be adjusted. For example, by arranging the oscillation elements in a lattice form and driving them in synchronization with each other, a square surface light source can be formed. In other words, according to the arrangement of the oscillation elements, the size or shape of an opening plane from which the terahertz wave are generated is adjusted. In the present disclosure, the shape of the surface light source may have two or more sides. The emission unit 102 includes an optical unit 104 that is disposed to correspond to the plurality of generation elements 103. The optical unit 104 converges the terahertz wave that propagates at a predetermined divergence angle from the generation elements 103. The optical unit 104 may be a collimator. For example, the optical unit 104 irradiates an object 106 with the terahertz wave formed as parallel beams. If the beam width of the collimated terahertz wave is smaller than a terahertz image sensor included in the detection unit 101, the detection unit 101 outputs, as an image, the shape of the surface light source of the generation elements 103 via the object 106. In other words, if the light beam is not significantly lost in the process of propagation of the terahertz wave, the shape of the surface light source of the generation elements 103 is projected on the detection unit 101. According to the arrangement of the set of the generation elements 103 and the optical unit 104, a desired beam pattern of the terahertz wave in accordance with the arrangement of the set can be projected on the detection unit 101. For example, by arranging the set of the generation elements 103 and the optical unit 104 in a checkered pattern, the beam pattern of the terahertz wave in which square light source patterns are arranged in a lattice form can be projected on the detection unit 101. In addition, as in FIG. 1, by linearly arranging the set of the generation elements 103 and the optical unit 104, a rectangular beam pattern of terahertz wave, in which the beam width differs in the longitudinal direction and the lateral direction, can be projected on the detection unit 101. In the present disclosure, the beam pattern of terahertz wave is also referred to as an irradiation pattern. In the present disclosure, the irradiation pattern may have two or more sides. Two or more sides enables reading of a plurality of pieces of information such as the interval between two sides, an opening angle therebetween, the degree of parallelization, and the difference in length, from the irradiation pattern, thereby increasing the ability of recognizing the distortion of the irradiation pattern.

The support unit 105 includes a stage, for example, and supports the object 106 by adjusting the posture thereof to a desired posture. The support unit 105 may include a movement unit that moves the position of the object 106 and adjusts the posture thereof. The support unit 105 may include a plurality of movement units. The object 106 includes a base 107 and a coating layer 108. The object 106 may be, for example, a photosensitive drum coated with an amorphous silicon layer. The object 106 may be, for example, a painted structure, such as a crosslink. The base 107 may be metallic or non-metallic. The coating layer 108 is closely adhered to the base 107. The coating layer 108 may be non-metallic. The coating layer 108 may be a single layer or a multi-layer.

An inspection surface of the object 106 includes one or more curved surfaces, a plurality of planar surfaces, and a combination of such a curved surface and a planar surface. In the example in FIG. 1, the base 107 is a cylindrical member and the coating layer 108 is a resin film. The resin film has a thickness that is less than or equal to the wavelength of the terahertz wave and has a thickness distribution. In the example in FIG. 1, the thickness of the resin film increases toward the end portions of the cylindrical member, and the object 106 as a whole has a recess structure in the center. Note that the shape of the object 106 is not limited to this. The emission unit 102 can radiate the terahertz wave having a specific irradiation pattern. When a virtual surface 109 crossing the terahertz wave radiated from the emission unit 102 is obtained, the terahertz wave has a specific shape. The irradiation pattern will be described later. The detection unit 101 detects a terahertz wave 110 reflected on the object 106. For example, the inspection system inspects the thickness distribution of the coating layer 108 from several micrometers to several tens of micrometers.

The inspection system may include a pattern determination unit 120, a distribution measurement unit 121, a posture control unit 122, a storage unit 123, a monitoring unit 124, an image processing unit 125, a storage unit 126, and an inspection unit 127. The inspection system may include a system control unit configured to control the overall system.

The monitoring unit 124 monitors the position or posture, such as the position or orientation of the object 106 corresponding to the state of the support unit 105. For example, the monitoring unit 124 is an appearance detection apparatus, such as a visual camera, or a position detection apparatus, such as a radar or a sensor, and outputs posture information of the inspection surface of the object 106 or posture information of the object 106 in a measurement region of the inspection system. In this embodiment of the present disclosure, the posture information of the inspection surface of the object 106 and the posture information of the object 106 may collectively be referred to as posture information of the object 106. Here, the inspection surface of the object 106 is a surface selected by the inspection system or an operator of the inspection system when the surface of the object 106 is virtually divided into a plurality of surfaces. The terahertz wave is incident on the inspection surface, and the reflected terahertz wave is detected by the detection unit 101.

The posture control unit 122 controls the state of the support unit 105. For example, the inspection surface selected by the inspection system or the operator of the inspection system is moved to the measurement region of the inspection system. At this time, referring to the posture information of the inspection surface output from the monitoring unit 124, the posture control unit 122 adjusts the posture of the inspection surface to a desired posture. As an example, the incident angle of the terahertz wave incident on the inspection surface is adjusted to a desired incident angle. Then, referring to the posture information of the object 106 output from the monitoring unit 124, the posture control unit 122 outputs coordinates information of the measurement region of the inspection system on the object 106. For example, the coordinates information is spatial coordinates virtually assigned in advance to the surface of the object 106. The spatial coordinates of the surface of the object 106 corresponding to the measurement region are output. Pixels of the detection unit 101 and the measurement region may be associated with each other, and the pixels and the spatial coordinates may be associated with each other. In addition, the coordinates information is identification information of the inspection surface of the object 106. The following case will be considered for example. As described above, the inspection surface of the object 106 is one of the surfaces obtained by virtually dividing the surface of the object 106, and a position on the object 106 and an identification number of the inspection surface are associated with each other in advance. At this time, by designating the identification number of the inspection surface as the identification information, an inspection part on the object 106 can be specified. If the posture of the inspection surface is adjusted by the support unit 105, a control amount of the support unit 105 may be applied together with the identification information. By applying the control amount of the support unit 105, the spatial position relationship between a plurality of inspection surfaces can be inferred. In addition, if there is three-dimensional model data of the object 106 in advance, the control amount of the support unit 105 may be the coordinates information. By the control amount of the support unit 105, a change in the spatial coordinates of the object 106 is predicted, and the spatial coordinates are calculated. The coordinates information is not limited to this, and may be any information by which a terahertz image output from the detection unit 101 and the position of the measurement region on the object 106 can be specified. The posture control unit 122 may control the state of the support unit 105 in accordance with the posture information of the monitoring unit 124.

Referring to image data output from the detection unit 101, the pattern determination unit 120 extracts the position, region, or shape of the irradiation pattern radiated from the emission unit 102 included in the image data.

The distribution measurement unit 121 outputs a pixel intensity distribution, which corresponds to the irradiation pattern extracted by the pattern determination unit 120. At this time, on an intensity distribution image of the irradiation pattern, information on the intensity distribution resulting from the physical property or shape of the object 106 in the measurement region is superposed and output. For example, in this embodiment, the intensity distribution image resulting from the physical property or shape of the object 106 is an image related to the thickness distribution of the coating layer 108, or the shape or scratches on the surface of the base 107 under the coating layer 108. The intensity distribution image is not limited to this. The image processing unit 125 refers to the coordinates information of the measurement region output from the posture control unit 122 (hereinafter also simply referred to as coordinates information of the measurement region) and the intensity distribution image resulting from the physical property or shape of the object 106. Then, the image processing unit 125 can combine the intensity distribution image in a wide range in accordance with the shape of the object 106. At this time, referring to the spatial coordinates information related to the shape of the object 106 stored in advance in the storage unit 123, the intensity distribution image may be three-dimensionally combined. This combined image is also referred to as a combined intensity distribution image. The storage unit 126 can store, as reference information, the combined intensity distribution image obtained from the object 106 and serving as a reference.

Referring to the intensity distribution image in a wide range, the inspection unit 127 inspects the shape or physical property of the object 106. For example, referring to the reference information of the shape or physical property of the object 106 stored in the storage unit 126, it is determined whether the shape or physical property is good or bad. The thickness of the coating layer 108 can be measured using the information from the surface of the base 107 and the information from the surface of the coating layer 108. In this case, the thicknesses may be output, for example, by the image processing unit 125 performing calculation on the basis of the output from the detection unit 101. In addition, the inspection system can observe the surface of the base 107 of the object 106.

Note that the inspection system may include a support unit for the emission unit 102 and the detection unit 101, and may include at least a movement unit for any of them. That is, by moving at least one of the object 106, the emission unit 102, and the detection unit 101, the measurement position of the object 106 can be changed.

The inspection system described in this embodiment can safely observe the base 107 coated with the coating layer 108. In addition, referring to the posture of the object, the intensity distribution image is combined in accordance with the shape of the object to conduct an inspection. Thus, application to an object having a free-form surface is easy.

Other units will be described. The detection unit 101 includes a detection element that can detect a terahertz wave. The detection element that can detect a terahertz wave is, for example, an antenna composed of a rectifier element and a conductor. As the rectifier element, a rectifying diode such as a Schottky barrier diode or a pn-junction using diode can be used. The detection unit 101 may further include an optical element of a focusing optical system, for example, a lens. The optical element is, for example, a lens of a focusing optical system. The optical element is formed of, for example, high-density polyethylene (HDPE), high-resistance silicon, Teflon (registered trademark) (polytetrafluoroethylene: PTFE), or the like.

The emission unit 102 includes the plurality of generation elements 103. The emission unit 102 may further include the optical unit 104. The emission unit 102 radiates the terahertz wave 110. Each of the generation elements 103 includes the plurality of oscillation elements that can oscillate the terahertz wave. The oscillation element that can oscillate the terahertz wave is composed of, for example, a negative resistive element and a resonator. The oscillation element is composed of, for example, as the negative resistive element, a resonant tunneling diode (RTD) and an antenna. By arranging these oscillation elements in an array form and driving them in synchronization with each other, they operate as a single surface light source. For example, by disposing the oscillation elements in a lattice form, the oscillation elements operate as a square surface light source. The optical unit 104 includes a plurality of optical elements. The optical element herein is a collimator, and may be configured by an upwardly protruding lens, for example. The optical unit 104 may be formed of a material transparent to the terahertz wave. The transparent material is, for example, high-density polyethylene, high-resistance silicon, Teflon, or the like. In FIG. 1, three generation elements 103 are arranged in one row and three columns, and one optical element is arranged to correspond to each one of the generation elements 103. Hereinafter, the top surface of the generation elements 103 is a generation surface of the terahertz wave.

As described above, the terahertz wave 110 that is collimated and output from the emission unit 102 has the irradiation pattern. The irradiation pattern is the beam pattern of the terahertz wave and the spatial intensity distribution of the terahertz wave. Parts of the terahertz wave radiated from the plurality of generation elements 103 are combined to form a single irradiation pattern. The irradiation pattern is composed of light beams of the terahertz wave. When the virtual surface 109 perpendicular to the terahertz wave 110 is obtained, in the virtual surface 109, the terahertz wave 110 exhibits a desired shape in accordance with the arrangement of the set of the generation elements 103 and the optical unit 104. The virtual surface 109 may be perpendicular to the terahertz wave; however, the irradiation pattern can be verified by using a surface crossing the optical axis of the terahertz wave. Specifically, by disposing the detection unit 101 on the virtual surface 109 and observing the intensity distribution image of the terahertz wave, the irradiation pattern can be verified. Alternatively, by disposing a reflective plane at the position of the object 106 and observing the intensity distribution image of the terahertz wave by using the detection unit 101, the irradiation pattern can be verified. The shape of the intensity distribution image may be referred to as the irradiation pattern, and the irradiation pattern of the terahertz light that is directly output without the object 106 or output via the object 106 serving as a reference, may be particularly referred to as a reference pattern. The reference pattern is, in other words, a pattern that is parallel to the optical axis of the emission unit 102. To recognize the pattern easily, the reference pattern may include two or more sides. The reference pattern may be, for example, a polygon such as a rectangle, an ellipse, or a lattice form. In addition, the reference pattern may be a shape having the longitudinal direction and the lateral direction. Here, in a desirable shape, the longitudinal direction of the reference pattern is a direction in which the average curvature on the surface of the base 107 is small. Alternatively, the support unit 105 that is a stage may move the object 106 to set the longitudinal direction of the reference pattern to the direction in which the average curvature on the surface of the base 107 is small. In FIG. 1, the set of the generation elements 103, which are square surface light sources, and the optical unit 104 are linearly arranged in one row and three columns. Thus, the reference pattern has a shape in which the square surface light source patterns are arranged in one row and three columns. By making the plurality of surface light sources close to each other, a rectangular reference pattern is formed. In the following description, the reference pattern is a rectangular reference pattern in which the length differs in the longitudinal direction and the lateral direction.

The inspection system moves any of the object 106, the emission unit 102, and the terahertz wave from the emission unit 102, to conduct an inspection. Here, on the basis of the coordinates information from the posture control unit 122 or monitoring information from the monitoring unit 124, the incident angle of the terahertz wave on the object 106 can be measured, and the incident angle can be adjusted. In FIG. 1, the posture control unit 122 controls the operation of the support unit 105 that is a stage, but may also control the posture of the detection unit 101 or the emission unit 102. In addition, on the basis of the output from the detection unit 101, the inspection system can measure the incident angle of the terahertz wave on the object 106 or adjust the inspection timing.

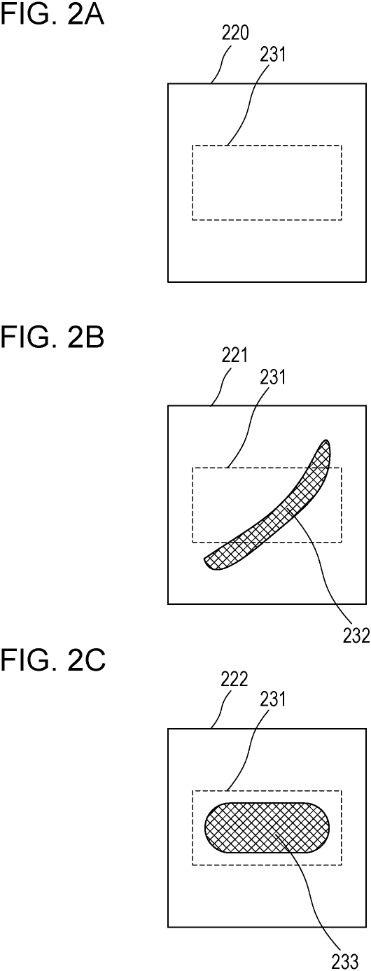

FIGS. 2A to 2C are schematic diagrams for describing patterns according to this embodiment. FIGS. 2A to 2C illustrate images based on the information obtained by the detection unit 101. FIG. 2A illustrates an image 220, FIG. 2B illustrates an image 221, and FIG. 2C illustrates an image 222.

The image 220 illustrated in FIG. 2A includes a reference pattern image 231. The image 220 is an image obtained when an object whose shape and material are known is used as the object. Here, for example, the reference pattern image 231 is an irradiation pattern obtained when a metal flat plate is disposed as the object 106. If the light beams of the terahertz wave generated by the emission unit 102 can be obtained by the detection unit 101 without any loss, a square pattern image can be detected as an aggregate of the plurality of surface light sources. By the emission unit 102 irradiating the object with the terahertz wave having the irradiation pattern including the reference pattern, the image 220 can be acquired. The image 220 can be used as a reference pattern image, and the operation for acquiring the image 220 is, in other words, imaging of the reference pattern. The image 220 including the reference pattern image 231 is stored in, for example, the pattern determination unit 120 in FIG. 1, and is used as a reference for determining the irradiation pattern.

The image 221 illustrated in FIG. 2B includes an image 232. The image 221 is an image based on information obtained using a target object to be inspected as the object, for example, the object 106 including the base 107 and the coating layer 108 illustrated in FIG. 1. More specifically, the image 221 represents an image in a state where a vector of the terahertz wave output from the emission unit 102 in the longitudinal direction of the irradiation pattern crosses a vector of the cylindrical base 107 in the longitudinal direction. In this case, since the terahertz wave is radiated such that the longitudinal direction of the terahertz wave having a rectangular shape crosses the longitudinal direction of the cylindrical base 107, the intensity distribution image is distorted (the image 232). Specifically, the intensity distribution in the longitudinal direction of the cylindrical base 107 has a narrow distribution region because an overlap with the terahertz wave is small, and the intensity distribution in the lateral direction of the base 107 is the image 232 enlarged in the lateral direction because the beams of the terahertz wave diffuse due to the cylindrical round structure. Note that the distorted shape of the image 232 is not limited to this, and the shape changes depending on the shape of the object 106 in the region overlapping with the irradiation pattern of the terahertz wave or the relative position relationship between the irradiation pattern and the object 106. By the emission unit 102 irradiating the object 106 with the terahertz wave having the irradiation pattern including the reference pattern, information for generating the image 221 can be acquired. At this time, in addition to the intensity distribution based on the physical property of the object 106, a signal resulting from the shape of the object 106 is detected as the distortion of the shape. The image 221 is, in other words, an image obtained when the distortion caused by the shape has a large influence. For example, to detect a small change in the physical property of the object 106 as the intensity distribution, these signal changes resulting from the shape of the object 106 may be suppressed. Note that the image 221 includes the reference pattern image 231 superposed on the image 232 in the illustrated example. The image 221 can be acquired by, for example, the image processing unit 125 combining the information acquired by the detection unit 101 and the image 220 stored in the pattern determination unit 120.

The image 222 illustrated in FIG. 2C includes an image 233. The image 222 is an image based on information obtained using a target object to be inspected as the object, for example, the object 106 including the base 107 and the coating layer 108 illustrated in FIG. 1. More specifically, the image 222 represents an image in a state where a vector of the reference pattern in the longitudinal direction is substantially the same as a vector of the cylindrical base 107 in the longitudinal direction. Since the vectors of the irradiation pattern of the terahertz wave and the cylindrical base 107 in the longitudinal direction are the same, a linear intensity distribution image (the image 233) that closely resembles the reference pattern image 231 can be acquired. By the emission unit 102 irradiating the object 106 with the terahertz wave having the irradiation pattern including the reference pattern, information for generating the image 222 can be acquired. Note that the image 222 includes the reference pattern image 231 superposed on the image 233. The image 222 can be acquired by, for example, the image processing unit 125 combining the information acquired by the detection unit 101 and the image 220 stored in the pattern determination unit 120.

The image 232 has a shape different from that of the reference pattern image 231. The image 233 has a shape similar to that of the reference pattern image 231. The area in which the image 233 and the reference pattern image 231 are superposed is larger than the area in which the image 232 and the reference pattern image 231 are superposed. The shape of the image 232 and the shape of the image 233 differ from each other in this manner when, for example, the incident angle of the terahertz wave on the surface of the base 107 of the object 106 differs. The shape of the image 232 and the shape of the image 233 also differ from each other when the shape of the object 106 in the region overlapping with the irradiation pattern of the terahertz wave differs, or when the relative position relationship between the irradiation pattern and the object 106 differs. For example, the relative position relationship between the object 106, the emission unit 102, and the detection unit 101 differs.

By monitoring the distortion state of the terahertz image, it is possible to determine whether the incident state of the terahertz wave on the surface of the base 107 is in a suitable state. For example, it is possible to determine whether the incident angle of the terahertz wave is in a suitable state. For example, it is possible to determine whether the influence of the shape of the surface of the base 107 is in a suitable state (whether the influence of the shape on the intensity distribution is suppressed). If the influence of the shape of the surface of the base 107 is in a suitable state, the intensity distribution image of the terahertz wave closely resembles the reference pattern. The determination can be performed by, for example, obtaining the area, the ratio, the shape, and the correlation of the intensity distribution of the region where the terahertz image and the reference pattern image 231 are superposed and comparing them with reference values thereof. If any reference value is not satisfied in the determination, the relative position relationship between the object 106, the emission unit 102, and the detection unit 101 is changed. Alternatively, the inspection is stopped.

In addition, a terahertz image may be acquired by using a known target object having a curved surface or an uneven surface, and it may be determined whether the target object has a curved surface or an uneven surface. Furthermore, the curved surface or the uneven surface of the object may be detected on the basis of a change in the shape of the terahertz image.

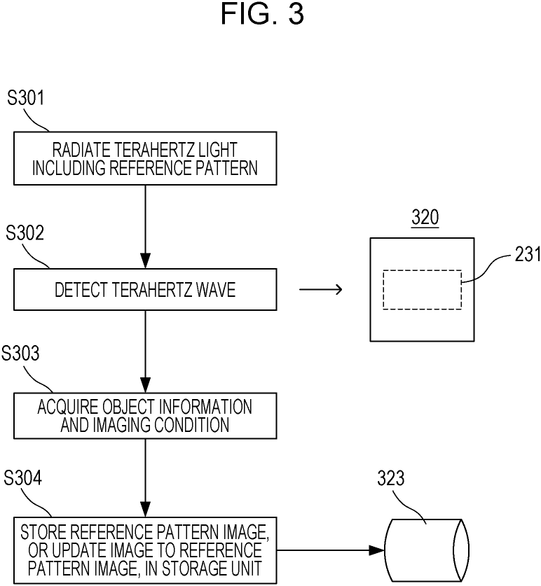

Now, operations will be described below with reference to FIGS. 3 to 6. FIGS. 3 to 6 are flowcharts for describing the operations of the inspection system according to this embodiment. Note that the order of steps is not limited to that in the flowcharts, and a plurality of steps may be concurrently performed, or the order of steps may be interchanged as appropriate.

FIG. 3 illustrates operations for acquiring the reference pattern image 231 illustrated in FIG. 2A.

In step S301, an object whose shape is grasped is the object, and the object is irradiated with the terahertz wave having the irradiation pattern including the reference pattern. The object may be a flat plate that reflects the terahertz wave or may be a reference object having the same shape as the object to be inspected. In step S302, the terahertz wave reflected on the object is detected by the detection unit 101. At this time, image information 320 including the reference pattern image 231 can be acquired. In step S303, object information and imaging conditions are acquired. The object information is shape information or surface information of the object. The object information may also be shape information or surface information of the base. The imaging conditions include the shape of the reference pattern image 231, the incident angle of the terahertz wave on the object, that is, the relative position between the emission unit 102, the detection unit 101, and the support unit 105 that is a stage, and the coordinates information of the support unit 105. In step S304, the reference pattern image 231 is stored, or an image is updated to the reference pattern image 231, in a storage unit 323 included in the pattern determination unit 120 illustrated in FIG. 1. At this time, the storage unit 323 can store the object information and imaging conditions as information associated with the reference pattern image 231. In accordance with this flow, the reference pattern image 231 can be acquired. Note that a plurality of reference patterns may also be used. For example, if the reference pattern is acquired by using the reference object, in accordance with the shape of the reference object, the shape of the reference pattern may change depending on the irradiation position of the terahertz wave with respect to the reference object. For the plurality of reference patterns, the storage unit 323 manages and stores the irradiation position of the terahertz wave and the object information and the imaging conditions for the irradiation position. The storage unit 323 may be included in the pattern determination unit 120 or may also be another storage unit.

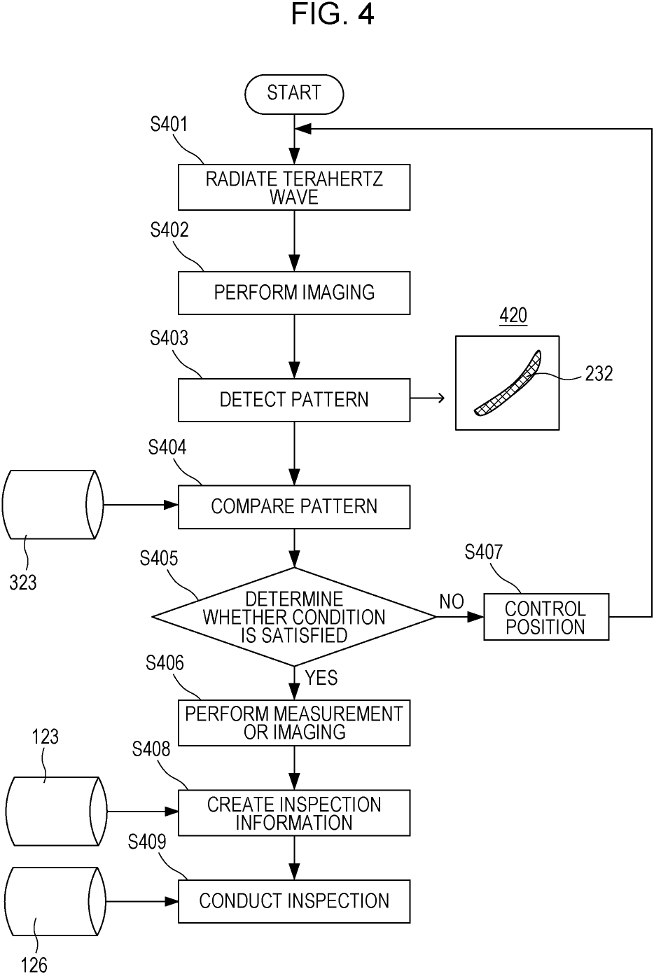

FIG. 4 illustrates operations performed when an inspection is conducted. In step S401, the terahertz wave is radiated. The emission unit 102 irradiates object to be inspected with the terahertz wave having the irradiation pattern including the reference pattern. In step S402, imaging is performed. The detection unit 101 detects the terahertz wave reflected on the object and acquires information 420. At this time, the information 420 may be image information. The information 420 may also be one-dimensional intensity distribution information. In step S403, the pattern determination unit 120 detects a pattern. To detect the pattern, the image 232 based on the terahertz wave reflected on the object is acquired from the information 420 acquired in step S402. For example, the information 420 is subjected to threshold processing, and the background and the intensity distribution image of the terahertz wave are distinguished from each other to extract the image 232. In addition, the information 420 is subjected to edge extraction processing to extract the outline of the image 232. In step S404, the pattern determination unit 120 compares the pattern. The image 232 acquired in step S402 is compared with the reference pattern image stored in the storage unit 323 in the pattern determination unit 120. In step S405, the pattern determination unit 120 determines the pattern. On the basis of the result of comparison in step S404, it is determined whether a reference value or condition are satisfied. For example, a match rate when the reference pattern image overlaps with the image 232 is determined, or the outer edges of the reference pattern image and the image 232 are acquired, and the resemblance between shapes of these outer edges is determined. If the reference value or condition for the match rate or similarity is satisfied, the detection unit 101 measures the object or images the object, and the distribution measurement unit 121 outputs the pixel intensity distribution corresponding to the image 232 (step S406). Alternatively, the distribution measurement unit 121 outputs the pixel intensity distribution corresponding to the image 232 on the basis of the information 420 used for determining the pattern. If the reference value or condition for the match rate or similarity is not satisfied, the position is controlled in step S407. To control the position, the posture control unit 122 in FIG. 1 controls the posture, the position, or the posture and position of at least one of the support unit 105 that is a stage, the detection unit 101, and the emission unit 102. Subsequently, the process returns to step S401.

If the reference value or condition for the match rate or similarity is satisfied in step S405, the object information, the obtained image 232, and the posture information, such as coordinates acquired by the posture control unit 122, may be accumulated in the storage unit 323 of the pattern determination unit 120. Such information can be used for increasing the determination accuracy using machine learning or the like.

In step S408, the image processing unit 125 creates information to be used for inspection (inspection information). For example, referring to the posture information of the object output from the posture control unit 122, the measurement region on the object may be specified, and the intensity distribution image of the terahertz wave may be overlapped and displayed on a three-dimensional model image of the object or a visual image thereof output from the monitoring unit 124. At this time, the posture information of the posture control unit 122 may be associated with the shape information of the object that is stored in the storage unit 123 in advance, and the position or posture of the intensity distribution image of the terahertz wave may be adjusted. Alternatively, the posture information (coordinates information) of the posture control unit 122 is associated with the shape information (spatial coordinates information) of the object stored in the storage unit 123 in advance. Subsequently, the intensity signal of each of pixels constituting the intensity distribution image of the terahertz wave may be assigned again to the coordinates corresponding to the three-dimensional model image of the object or the visual image thereof. Alternatively, if a plurality of intensity distribution images of the terahertz wave are acquired, intensity signals of the terahertz wave may be sequentially assigned to the three-dimensional model image of the object or the visual image thereof and combined to create one piece of inspection information. In other words, information on the intensity distribution of the entire object is created from information on the intensity distribution of the terahertz wave measured locally.

In addition, by using the reference object, the intensity distribution information may be generated on the basis of the reference pattern image, and the created inspection information can be stored in the storage unit 126 as reference inspection information.

In step S409, referring to the inspection information output from the image processing unit 125, the inspection unit 127 conducts the inspection of the object. For example, the reference inspection information stored in the storage unit 126 is compared with the inspection information output from the image processing unit 125, differences therebetween are checked, and it is determined whether the inspection information is good or bad.

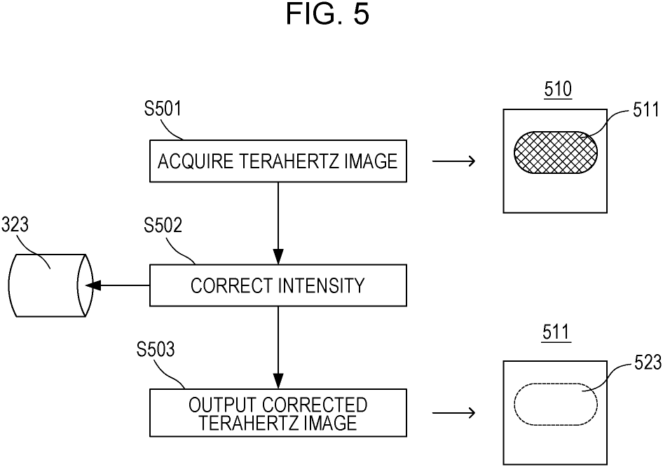

FIG. 5 briefly illustrates a flow of image processing performed in the pattern determination unit 120 for image correction as an example of the image processing. The inspection system can perform the operations in step S501 to S503 in, for example, steps S402 and S403, which are steps for detecting the pattern in FIG. 4.

Step S501 is a terahertz image acquisition step. Step S501 is a so-called imaging step and corresponds to, for example, step S402 in FIG. 4. The terahertz image to be acquired is an image obtained by the detection unit 101 detecting the terahertz wave that is emitted from the emission unit 102 in FIG. 1 and is reflected on the object 106. The terahertz image to be acquired is, in other words, image information 510. As described above, the image information 510 is an intensity distribution image 511 including the irradiation pattern serving as a reference (reference pattern image) and information resulting from the physical property or shape of the object. In this embodiment of the present disclosure, the terahertz wave generated from the generation elements 103 is coherent because the phase is adjusted and synchronized in the oscillation elements constituting the generation elements 103. Thus, parts of the terahertz wave generated from the plurality of generation elements 103 may interfere with each other in some cases. When the terahertz wave is transmitted through the optical unit 104, interference resulting from the external shape of the optical unit 104 may be superposed on the terahertz wave. In addition, parts of the terahertz wave may interfere with each other due to the lens or opening in an input stage of the terahertz wave in the detection unit 101 and may be superposed on the signal of the terahertz wave. A signal resulting from such interference may be superposed on the image information 510. In this embodiment of the present disclosure, this signal resulting from the interference may particularly be referred to as light source unevenness. For example, if the light source unevenness is superposed on the reference pattern, at the time of detecting the pattern in step S403 or the like, the light source unevenness pattern may be erroneously detected as a pattern resulting from the object. Thus, the light source unevenness may be suppressed. The erroneous pattern detection may induce, for example, a decrease in the inspection ability in the subsequent inspection step (step S409). The process in FIG. 5 illustrates an example of a process for suppressing the light source unevenness.

If a flat plate that reflects the terahertz wave or a reference object having the same shape as the object to be inspected is used as the object in step S501, the intensity distribution image 511 in the image information 510 is an image including the reference pattern and the light source unevenness pattern. For example, from the intensity distribution image 511 resulting from the reference pattern and the light source unevenness, intensity correction data for suppressing the light source unevenness pattern is set for each pixel. In this embodiment of the present disclosure, the intensity correction data for each pixel is also referred to as pixel correction data. For example, the pixel correction data is created such that the intensity of the intensity distribution image 511 becomes uniform.

Such correction data may be stored in the storage unit 323 in the pattern determination unit 120.

Step S502 is an intensity correction step. In step S502, by using the pixel correction data that is the intensity correction information of the storage unit 323, the image information 510 is corrected. In this processing, information on the light source unevenness is removed from the intensity distribution image 511 in the image information 510. This removal processing is, for example, subtraction processing for adjusting the basis of the intensity signal, a division processing for adjusting the amplitude of the intensity signal, or a combination of the subtraction processing and the division processing. The removal processing is not limited to these. For example, if the intensity signal of the light source unevenness changes non-linearly, the terahertz wave to be input to the detection unit 101 may be corrected according to an approximation, or a plurality of gradually changing pieces of pixel correction data may be prepared in accordance with the intensity of the terahertz wave to be input. Here, the intensity is corrected for the pixels included in the intensity distribution image 511 in step S501. The region in which the intensity is to be corrected is also referred to as correction region.

Step S503 is a terahertz image output step. In step S503, image information corrected in step S502 is output. The image information is, for example, the intensity distribution image 511. In the intensity distribution image 511, a correction region 523 is corrected in the correction step, and an object image in which the influence of the light source unevenness due to the emission unit 102 is reduced can be obtained.

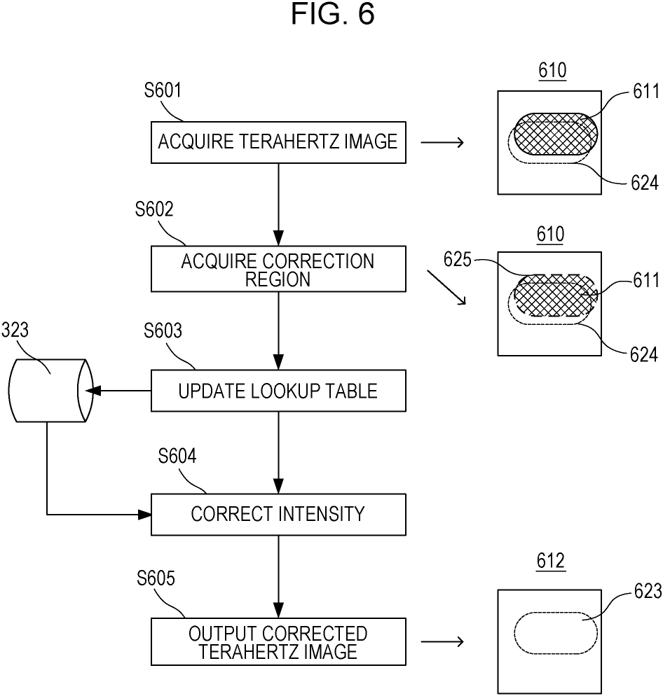

FIG. 6 is a modification example of image processing performed in the pattern determination unit 120 described in FIG. 5 and briefly illustrates the flow for updating information for image processing. The inspection system can perform the operations in steps S601 to S605.

Step S601 is a terahertz image acquisition step. Step S601 is a so-called imaging step and corresponds to, for example, step S402 in FIG. 4. The terahertz image to be acquired is an image obtained by the detection unit 101 detecting the terahertz wave that is generated by the emission unit 102 in FIG. 1 and is reflected on the object 106. The terahertz image to be acquired is, in other words, image information 610. The image information 610 is an intensity distribution image 611 including the reference pattern image, information resulting from the physical property or shape of the object, and the light source unevenness. Here, as described in FIG. 5, in the image information 610, a correction region derived from the intensity correction information that is stored in the storage unit 323 in the pattern determination unit 120 in advance is illustrated as a correction region 624. In other words, the region for which the pattern determination unit 120 is to correct the light source unevenness is illustrated as the correction region 624.

Step S602 is a correction region acquisition step. In step S602, a correction region 625 is acquired from an intensity distribution image 610 that is image information. For example, the intensity distribution image 611 is subjected to the threshold processing or the edge extraction processing, thereby obtaining the boundary of the correction region 625. Subsequently, the position information of the correction region 625 is acquired, and a misalignment amount of the position or inclination with respect to the correction region 624 is acquired. The misalignment amount may be obtained for each pixel.

Step S603 is an update processing step for a lookup table included in the storage unit 323 in the pattern determination unit 120. The lookup table stores pixel positions at which correction is to be performed and pixel correction data at each pixel position. On the basis of the misalignment amount obtained in step S602, at least information on pixel positions at which correction is to be performed is updated in the intensity correction information in the lookup table. In other words, the correction region 624 is moved to the correction region 625. If the misalignment amount is zero, the position information in the intensity correction information in the lookup table is not necessarily updated.

Step S604 is an intensity correction step. By using the pixel correction data in the updated lookup table, the image information 610 is corrected. Here, the position information is updated in the pixel correction data, and thus, the position of the correction region 625 illustrated in the image information and the position of a correction region 623 correspond to each other.

Step S605 is a terahertz image output step. In step S605, image information 612 corrected in step S604 is output. In the image information 612, the correction region 623 is corrected, and a suitable object image in which the light source unevenness is suppressed can be obtained.

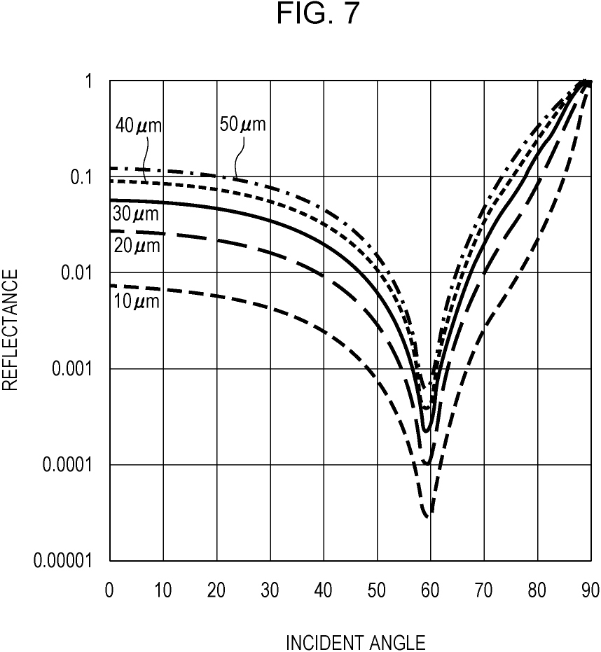

Furthermore, a method for measuring a film thickness by using the inspection system according to this embodiment will be described with reference to FIG. 7. FIG. 7 illustrates the incident angle of the terahertz wave on the object 106 and the reflectance on the surface of the base 107 at the incident angle. Here, the terahertz wave is incident on the object 106 as a p-polarized wave. The reflectance is, in other words, the intensity of the reflected terahertz wave to be detected by the detection unit 101. The values in FIG. 7 are obtained when the incident angle of the terahertz wave and the reflectance are measured by using the object 106 serving as a reference. The object 106 serving as a reference means an object for which the shape of the base 107 and the material and thickness of the coating layer 108 are acquired. Here, from the image information measured or acquired in the imaging in step S406 in FIG. 4 and the position information at this time, the incident angle and the intensity distribution information can be obtained. From the obtained incident angle and the intensity distribution information, on the basis of the information in FIG. 7, the thickness of the coating layer 108 can be inferred.

FIG. 1 illustrates a signal path in which the posture control unit 122 and the storage unit 123 are directly connected to each other. However, in the signal path, a processing unit, for example, may be disposed between the posture control unit 122 and the storage unit 123. In addition, the posture control unit 122, the image processing unit 125, or the like may be configured as the same processor (e.g., processing chip, processing board).

Two-dimensional image information is used for the description of this embodiment. However, one-dimensional image information or a one-dimensional intensity distribution image may also be used.

According to the configuration in this embodiment, for example, the surface shape or position of the object 106 can be detected and corrected at a suitable angle. In addition, by correcting the intensity distribution by using the reference pattern image, a suitable terahertz image can be obtained.

### Second Embodiment

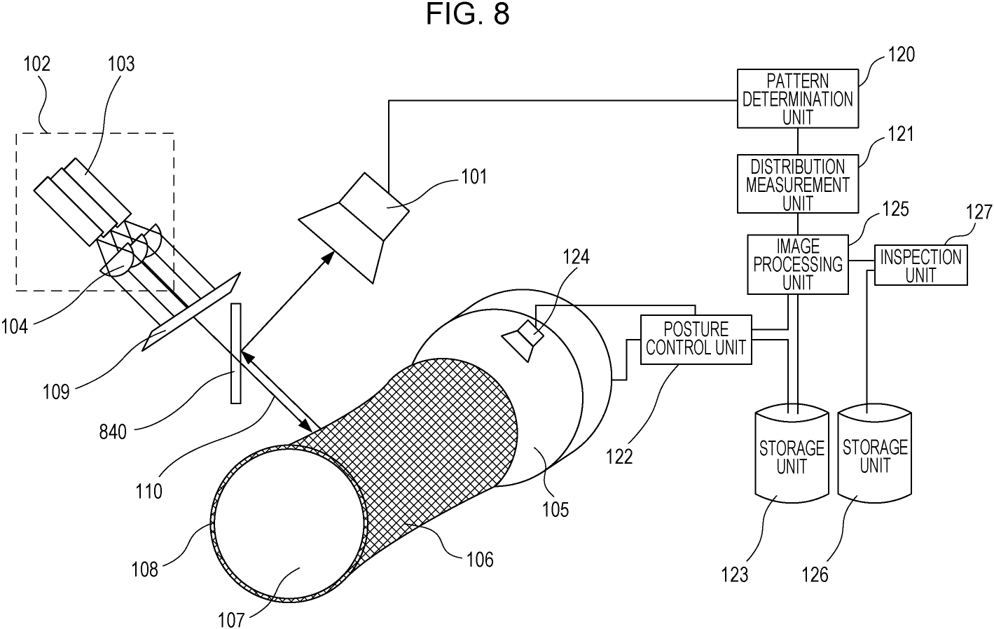

An inspection system according to this embodiment will be described with reference to FIG. 8. FIG. 8 is a schematic diagram for describing the configuration of the inspection system. FIG. 8 is similar to FIG. 1, and the same configuration as that in FIG. 1 will be omitted from the description. The inspection system according to this embodiment includes a half mirror 840 between the emission unit 102 and the object 106, or between the object 106 and the detection unit 101. With the half mirror 840, the incident angle of the terahertz wave including the reference pattern on the surface of the object 106 becomes approximately 0 degrees, and the incident angle of the terahertz wave including the reference pattern, reflected on the surface of the object 106, on the detection unit 101 becomes approximately 0 degrees. With such an incident angle, the detection accuracy of the reference pattern is increased, and a more accurate inspection is enabled.

### Third Embodiment

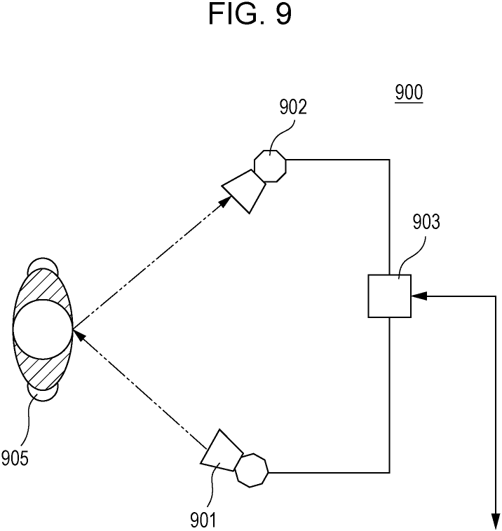

A camera system according to this embodiment will be described with reference to FIG. 9. FIG. 9 is a schematic diagram for describing the configuration of a terahertz-wave camera system 900. Individual members such as the emission unit, the detection unit, and the image processing unit have been described in the other embodiments and will be omitted from the description below.

The camera system 900 includes an emission unit 901, a detection unit 902, and an image processing unit 903. A terahertz wave radiated from the emission unit 901 is reflected on an object 905 and is detected by the detection unit 902. The image processing unit 903 processes a signal detected by the detection unit 902. Image data generated by the image processing unit 903 is output from an output unit. With such a configuration, a terahertz image can be acquired.

Also in such an embodiment, an image not dependent on the surface shape of the object 905 can be acquired by radiating the terahertz wave including the reference pattern Other Embodiments

As the optical unit in each embodiment, any configuration can be selected, such as a Fresnel lens, a cylindrical lens, an elliptical lens, a convex lens, a concave lens, and a biconvex lens. Furthermore, the optical unit 104 or the like may be an optical element such as a prism. The optical unit may include at least one of materials transparent to the terahertz wave, such as polyethylene, Teflon, high-resistance silicon, and polyolefin resin and may be composed of a plurality of layers. Further, the optical unit may have a structure in which a plurality of optical elements are integrated, or may have a structure having independent optical elements. With such an optical unit, it is possible to improve the detection accuracy of the reference pattern when radiating or detecting the terahertz wave including the reference pattern.

The optical unit may have an antireflection film or an antireflection structure for reducing the reflection of the terahertz wave on at least one of the upper outer edge and the lower outer edge thereof. The upper outer edge is, in other words, the outer edge on the emission side, and the lower outer edge is, in other words, the outer edge on the incident side.

The image processing in each embodiment may be executed by artificial intelligence processing (AI processing). Furthermore, the image processing in each embodiment can be changed as appropriate, such as performing some AI processing in a processing circuit or the like and performing the remaining processing in the cloud.

In each embodiment, the operation of the emission unit may be controlled according to the measured intensity distribution results. The operating conditions, such as the power of each emission unit or each generation element, may be individually controlled so that the intensity distribution becomes a desired distribution.

The camera system described in each embodiment is merely an example, and may have another form. In particular, the information acquired by the system is not limited to image information, and the camera system may also be a detection system that detects a signal.

Each embodiment merely illustrates an example of embodiment, and the technical scope of the present disclosure should not be construed in a limited manner by these. That is, embodiments of the present disclosure can be implemented in various forms without departing from the technical idea or its main features.

According to the above embodiments, it is possible to provide a terahertz-wave inspection system that enables at least highly accurate measurement and a method for controlling the inspection system.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2021-157911, which was filed on Sep. 28, 2021 and which is hereby incorporated by reference herein in its entirety.

What is claimed is:

1. An inspection system for inspecting an object including a base and a coating layer that coats the base, the inspection system comprising:
an emission unit configured to irradiate the object with a terahertz wave including at least a reference pattern;
a support unit configured to adjust a relative position between the emission unit and the object;
a detection unit configured to detect the terahertz wave reflected on the object and acquire a terahertz image; and
a determination unit configured to determine, from a shape of the terahertz image, whether an incident angle of the terahertz wave on the object is a predetermined incident angle.

2. The inspection system according to claim 1, wherein
the reference pattern includes a shape having at least two sides.

3. The inspection system according to claim 1, wherein
the emission unit includes one or more generation elements and an optical unit configured to collimate the terahertz wave by forming a pair with the one or more generation elements, and
the one or more generation elements are a surface light source formed by combining, as an array, a plurality of oscillation elements that oscillate the terahertz wave.

4. The inspection system according to claim 3, wherein
the reference pattern is a pattern in accordance with arrangement of a set of the one or more generation elements and the optical unit, and
the reference pattern is composed of light beams that are parallel to an optical axis of the emission unit and exhibits a given shape on a plane perpendicular to the optical axis.

5. The inspection system according to claim 1, wherein the determination unit infers the incident angle from a correlation between the reference pattern and the shape of the terahertz image.

6. The inspection system according to claim 1, further comprising
a distribution measurement unit configured to, if the determination unit determines that the incident angle is the predetermined incident angle, acquire an intensity distribution image of the terahertz wave from the terahertz image acquired by the detection unit.

7. The inspection system according to claim 1, further comprising
a posture control unit configured to output a signal for controlling a position of the support unit and output coordinates information of the support unit.

8. The inspection system according to claim 7, further comprising
a monitoring unit configured to acquire the coordinates information of the support unit.

9. The inspection system according to claim 7, further comprising
a storage unit configured to store shape information of the object, wherein
the posture control unit outputs the coordinates information for controlling the position of the support unit by referring to the shape information.

10. The inspection system according to claim 1, further comprising
a posture control unit configured to output a signal for controlling a position of the support unit and output coordinates information of the support unit;
a monitoring unit configured to acquire the coordinates information of the support unit;
a distribution measurement unit configured to, if the determination unit determines that the incident angle is the predetermined incident angle, acquire an intensity distribution image of the terahertz wave from the terahertz image acquired by the detection unit; and
an image processing unit configured to output a combined intensity distribution image in which the intensity distribution image is assigned to a shape of the object from the intensity distribution image and the coordinates information.

11. The inspection system according to claim 10, further comprising
an inspection unit configured to inspect a thickness of the coating layer from an intensity distribution in the combined intensity distribution image.

12. The inspection system according to claim 11, further comprising
a storage unit configured to store reference information generated by the inspection unit, wherein
the inspection unit determines whether a thickness distribution is good or bad by referring to the reference information.

13. The inspection system according to claim 12, wherein the reference information is a detected terahertz intensity distribution image of the coating layer.

14. The inspection system according to claim 1, wherein the reference pattern is rectangular.

15. The inspection system according to claim 1, wherein the reference pattern is a lattice form.

16. An inspection system comprising:
an emission unit configured to oscillate a terahertz wave;
a detection unit configured to detect the terahertz wave and acquire an image;
a support unit configured to support an object including a base and a coating layer that coats the base;
a determination unit configured to compare a first image serving as a reference and a second image acquired by detecting the terahertz wave reflected on the object with each other and determine whether an incident angle of the terahertz wave on the object is a predetermined incident angle; and
a posture control unit configured to control, based on a result obtained by the determination unit, a posture of at least one of the emission unit, the detection unit, and the support unit.

17. A method for controlling an inspection system including:
an emission unit configured to oscillate a terahertz wave;
a detection unit configured to detect the terahertz wave; and
a support unit configured to support an object, the method comprising:
oscillating a terahertz wave having a pattern and acquiring a first image serving as a reference;
detecting the terahertz wave reflected on the object and acquiring a second image;
comparing the first image and the second image with each other; and
controlling, based on a result obtained by the comparing, a posture of at least one of the emission unit, the detection unit, and the support unit.
